(19) United States
(12) Patent Application Publication
(10) Pub. No.: US 2007/0165823 A1
(43) Pub. Date: Jul. 19, 2007

(54) Call-based advertising

(76) Inventors: Randolph M. Haldeman, Menlo Park, CA (US); Leo Chiu, South San Francisco, CA (US); Donald R. Steul, San Francisco, CA (US); David J. Holsinger, Chicago, IL (US)

Correspondence Address: Innovation Strategies, Inc., P.O. Box 48577, Spokane, WA, 99228, US

(21) Appl. No.: 11/635,375

(22) Filed: Dec. 6, 2006

Related U.S. Application Data
(60) Provisional application No. 60/743,047, filed on Dec. 16, 2005.

(51) Int. Cl. H04M 3/42

(52) U.S. Cl. 379/218.01

(57) ABSTRACT

After receiving a directory assistance request from a caller, an attempt is made to determine the identity of the caller. If the caller's identity cannot be determined, a sponsor advertisement is played prior to providing the directory assistance service to the caller. If the caller's identity is determined, multiple advertisements of possible interest to the caller are identified. Each of the multiple advertisements has an associated bid price. An advertisement is selected based on the highest associated bid price. The selected advertisement is then played to the caller.

### RELATED APPLICATIONS

This application claims the benefit of U.S. Provisional Application No. 60/743,047, filed Dec. 16, 2005, the disclosure of which is incorporated by reference herein.

This application is related to U.S. patent application Ser. No. ______, filed on Dec. 6, 2006, entitled “Call-Based Advertising”, and identified by Docket No. APPT-003.US.

This application is related to U.S. patent application Ser. No. ______, filed on Dec. 6, 2006, entitled “Call-Based Advertising”, and identified by Docket No. APPT-004.US.

### TECHNICAL FIELD

The present invention relates to providing various types of advertisements to callers, such as telephone users.

### BACKGROUND

Individuals place a large number of telephone calls every day. These calls include Directory Assistance (DA) calls, Voice-over-Internet-Protocol (VoIP) calls, and enterprise content calls, such as requests for movies, information, and directions. For instance, in 2005 over 6 billion directory assistance calls were placed, billions of VoIP calls were placed, and tens of millions of enterprise content calls were placed. In many situations, consumers pay for these calls directly, such as with the service fee many directory assistance providers charge. Another way to finance certain calls is to have them sponsored by one or more advertisers.

To facilitate sponsored calls, it would be desirable to provide a management system that handles the distribution of ads to callers in different manners.

### BRIEF DESCRIPTION OF THE DRAWINGS

Similar reference numbers are used throughout the figures to reference like components and/or features.

FIG. 1 illustrates an example environment in which the systems and methods discussed herein can be applied.

FIG. 2 is a block diagram illustrating various components of an example advertisement management system.

FIG. 3 is a flow diagram illustrating an embodiment of a procedure for creating and editing advertisements.

FIGS. 4-7 represent a flow diagram that illustrates an embodiment of a procedure for playing one or more advertisements to a caller.

FIG. 8 is a block diagram illustrating an example computing device.

### DETAILED DESCRIPTION

The systems and methods described herein allow advertisers to create and manage multiple advertisements, such as voice-based advertisements, targeted by various parameters. These parameters include, for example, geographic area, business category, time-of-day, day-of-week, advertising budget, throttle settings, coupons, and the like. An example advertisement references an audio file and/or a text-to-speech transcript for generating an audio advertisement played to one or more callers. A caller is any person that uses any type of communication system and method to exchange audio data with another person, system, or entity. The systems and methods described herein allow advertisers to create advertisements that can target consumers at the instant they are making a buying decision (e.g., when a consumer calls a directory assistance service requesting a particular business or product/service).

In particular embodiments, a “user” is also referred to as a “caller”. The systems and methods described herein receive calls (or requests for calls) from various callers. For example callers may place calls to request directory assistance (also referred to as “411 service”), call a business, call a friend, and so forth. The caller may invoke a call via a conventional telephone system, using voice over internet protocol (VoIP), using a mobile phone over a wireless network, or any other communication system. Directory assistance typically provides a phone number for a particular individual or business. Directory assistance systems may also connect the caller to the desired individual number. Alternatively, directory assistance may provide any type of information to a caller, such as address information, business location, business hours, etc.

Particular examples discussed herein refer to receiving directory assistance requests from callers via a telephone or a cellular phone. However, the systems and methods discussed herein may also be utilized to process requests received from any source using any type of data communication mechanism and any kind of data response mechanism. Although certain examples provided herein refer to calls for directory assistance, similar procedures and systems can be used to provide in-call advertisements for any type of call, including VoIP calls, calls to businesses, calls to individuals, and the like. For example, a caller initiating a VoIP call may hear an advertisement “This call is being sponsored by Acme Computer Systems” before the call is connected to the destination. Revenue from this type of advertisement helps reduce or eliminate the cost of providing the VoIP call service.

Specific examples discussed herein relate to voice advertising (e.g., playing voice or other audio-based messages to callers). However, the systems and methods discussed herein can be used with any type of advertising and with any type of advertisement management system. Alternate types of messages include text messages, email messages, instant messages, graphics and the like. The described systems and methods may be implemented as a stand-alone system or may be incorporated into one or more other systems.

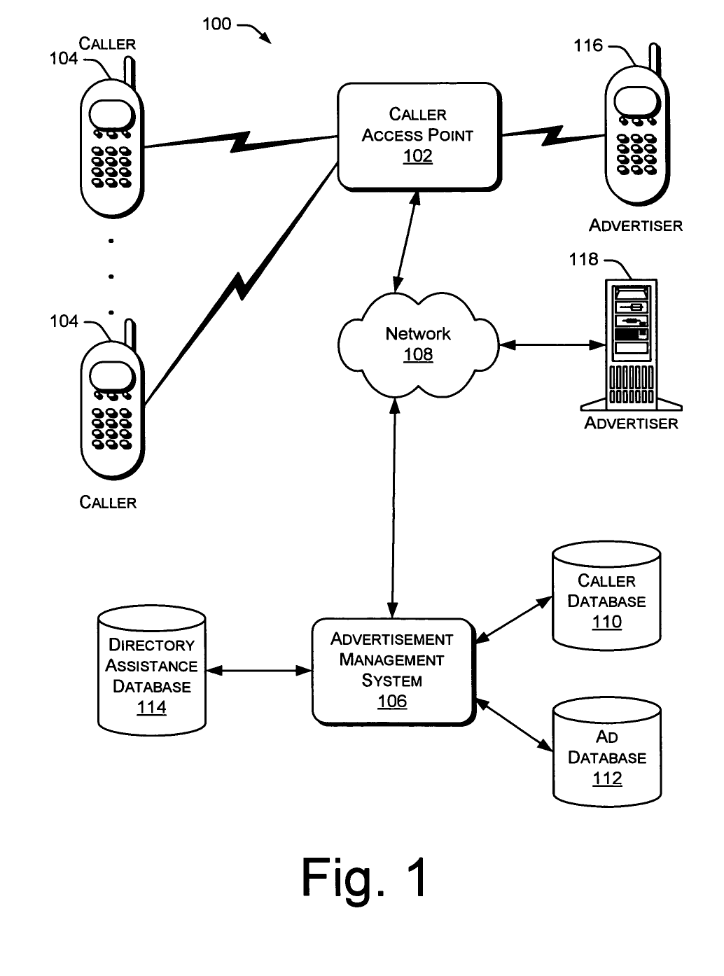

FIG. 1 illustrates an example environment 100 in which the systems and methods discussed herein can be applied. Environment 100 includes a caller access point 102, which receives calls from multiple callers 104. A typical caller access point 102 is capable of handling numerous calls from callers 104 simultaneously. Caller access point 102 may be a PBX phone system or other system capable of handling multiple calls simultaneously. In a particular embodiment, caller access point 102 is a directory assistance access point that receives requests from callers for directory assistance.

Caller access point 102 communicates with an advertisement management system 106 via a data communication network 108. Advertisement management system 106 performs various advertisement-related functions, such as creating and editing advertisements, selection and ranking of advertisements based on various factors, and playing advertisements to callers. Additional details regarding the operation of advertisement management system 106 are provided below.

Data communication network 108 can be implemented using any communication protocol and any type of communication medium. In one embodiment, data communication network 108 is the Internet. In other embodiments, data communication network 108 is a combination of two or more networks coupled to one another. Caller access point 102 and advertisement management system 106 communicate with network 108 via a wired and/or wireless communication link. In a particular embodiment, caller access point 102 and advertisement management system 106 communicate audio data using a VoIP. This embodiment may utilize a VoIP bridge or gateway between caller access point 102 and network 108, and between advertisement management system 106 and network 108.

Advertisement management system 106 is also coupled to a caller database 110, an advertisement database 112, and a directory assistance database 114. Caller database 110 contains information related to various callers, such as types of businesses requested in previous calls, types of advertisements received during previous calls, geographic location of the caller, caller demographics, and the like. This caller information allows advertisement management system 106 to target appropriate ads to the caller. Advertisement database 112 contains various advertisements and information associated with those advertisements. Advertisement database 112 also contains advertisement campaign history data used for reporting, generating new advertising campaigns, and so forth. Directory assistance database 114 contains phone numbers, addresses, and other information associated with numerous businesses and individuals. Although three separate databases 110, 112, and 114 are shown in FIG. 1, alternate embodiments may include any number of databases coupled to advertisement management system 106. Further, alternate embodiments may combine database information into more or less than three databases. For example, caller database 110 and advertisement database 112 may be merged into a single database. Similarly, the data contained in caller database 110 may be distributed across multiple databases (e.g., one database for caller data mined by advertisement management system 106, and a second database for caller data obtained from a third party data source).

Caller access point 102 is also accessible by an advertiser 116 using a telephone or similar communication device. For example, advertiser 116 may communicate with advertisement management system 106 via caller access point 102 to create or edit an advertisement. Alternatively, an advertiser 118 may communicate with advertisement management system 106 via a network connection through network 108. For example, advertiser 118 may communicate with advertisement management system 106 to create or edit an advertisement, review historical campaign data, or generate a report of advertising activity.

In a particular embodiment, caller access point 102 includes an invoking application, which interacts with callers and invokes advertising management system 106. The invoking application can be a directory assistance application, a VoIP application, an interactive voice response (IVR) application—such as for a supermarket, department store or movie theater, and the like. In one implementation, the invoking application receives a call and requests one or more advertisements from advertising management system 106. Advertising management system 106 then identifies advertisements based on information associated with the received call and provides those advertisements to the invoking application for playback to the caller. The invoking application then reports information about the advertisements back to advertising management system 106. The reported information includes, for example, which ads were played to the caller, which ad was selected by the caller, and whether the caller accepted any offers, such as competitor coupons or competitor discounts. This reported information is used by advertising management system 106 to provide advertising statistics and results to the advertisers placing the various advertisements. In one embodiment, an application program interface (API), discussed below, is provided by advertising management system 106 that allows one or more invoking applications to interact with the advertising management system.

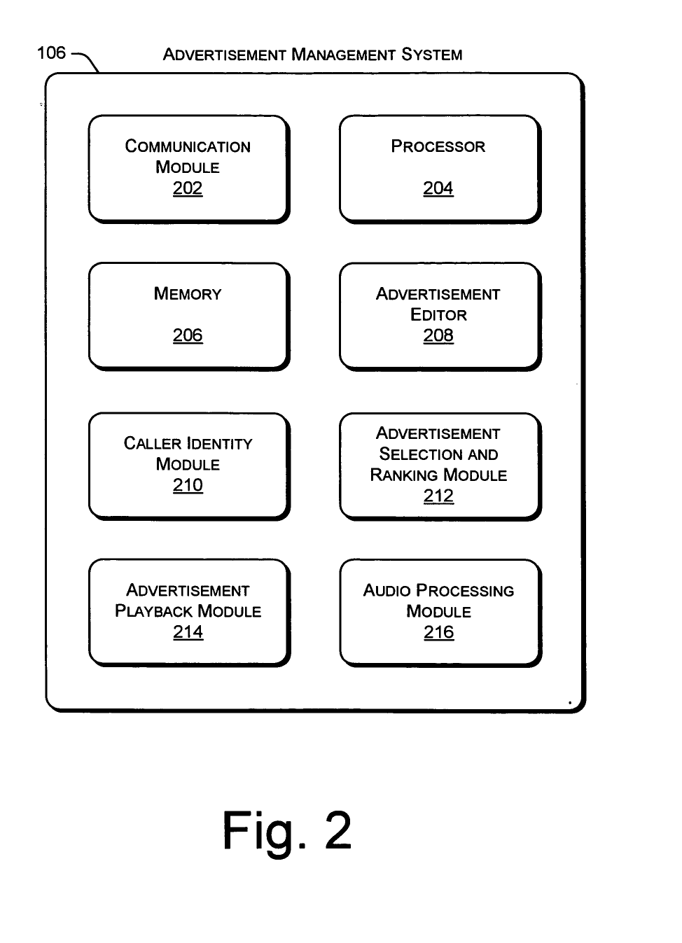

FIG. 2 is a block diagram illustrating various components of example advertisement management system 106. Advertisement management system 106 includes a communication module 202, a processor 204, and a memory 206. Communication module 202 allows advertisement management system 106 to communicate with other devices, such as databases, networks, other computer systems, and so on. Processor 204 executes various instructions to implement the functionality provided by advertisement management system 106. Memory 206 stores these instructions as well as other data used by processor 204 and other modules contained in advertisement management system 106.

Advertisement management system 106 also includes an advertisement editor 208, which allows users (e.g., advertisers, certified marketing representatives (CMR's), and ad agencies) to create and edit advertisements. Advertisement editor 208 also allows users to define various parameters associated with each advertisement, such as the business category, geographic location to target the advertisement, time of day to run the advertisement, maximum bid price, and the like. Users can access advertisement editor 208 via a telephone or via a network connection (e.g., through the Internet). Additional information regarding creating and editing advertisements is discussed below.

Advertisement management system 106 further includes a caller identity module 210, which determines the identity of a caller. For example, caller identity module 210 may receive a phone number associated with an incoming call. Caller identity module 210 accesses a caller database or other data source to determine the identity of the caller. Once the caller is identified, additional information about the caller can be retrieved from caller database 110 or another internal or external data source. This additional information includes, for example, information requested from previous directory assistance calls, previous advertisements played to the caller, demographics of the caller, environmental factors, and the like. Example environmental factors include the current temperature in a geographic area and whether snow is forecast for the area. Such additional information is useful in targeting advertisements of interest to the caller.

Advertisement management system 106 also includes an advertisement selection and ranking module 212. This module selects one or more advertisements to be played to a caller based on various factors, which are discussed in greater detail herein. Advertisement selection and ranking module 212 also ranks multiple advertisements based on one or more criteria. This ranking determines the order in which the multiple advertisements are presented (e.g., played) to the caller. An advertisement playback module 214 plays advertisements in the form of audio files, text-to-speech data, or other data to one or more callers. Advertisement playback module 214 performs the necessary data processing to convert the advertisement data into audible sounds that are communicated to the caller.

An audio processing module 216 performs various filtering and other modifications to audio recordings to improve the sound quality of the audio advertisement and to maintain consistent volume levels, consistent audio quality, and the like between multiple audio recordings. For example, audio processing module 216 may reduce background noise, reduce “clicks and pops” in the recording, modulate the frequencies in the recording, and generally smooth the audio sounds. These audio processing steps are particularly useful for audio advertisements created by an advertiser calling from a poor quality telephone connection.

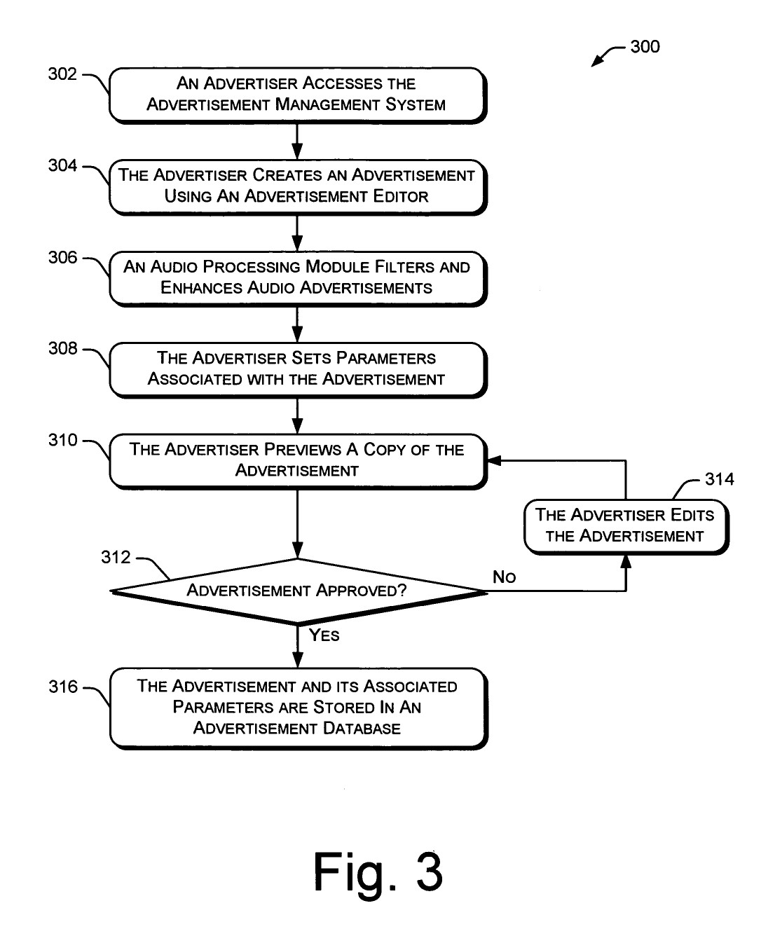

FIG. 3 is a flow diagram illustrating an embodiment of a procedure 300 for creating and editing advertisements. Initially, an advertiser accesses advertisement management system 106 discussed above (block 302). The advertiser can access the advertisement management system by telephone or via the data communication network shown in FIG. 1. The advertiser continues by creating (or editing) an advertisement using an advertisement editor (block 304), such as advertisement editor 208 shown in FIG. 2.

After creating or editing an advertisement, an audio processing module filters and enhances the audio portion of the advertisement (block 306). For example, the audio processing of block 306 can perform the audio processing discussed above with respect to audio processing module 216 in FIG. 2. Procedure 300 continues as the advertiser sets parameters associated with the advertisement (block 308). Example parameters include type of advertisement, business category, maximum bid price, and times that the advertisement can be played. Table 1 below identifies various parameters that can be associated with a particular advertisement.

After setting parameters associated with an advertisement, the advertiser previews a copy of the advertisement (block 310). This preview of the advertisement includes listening to the audio portion of the advertisement, viewing any visible portions of the advertisement, and reviewing the parameter settings associated with the advertisement. The parameter settings may be provided to the advertiser audibly or visually. If the advertiser approves the advertisement at block 312, procedure 300 continues to block 316 where the advertisement and its associated parameters are stored in an advertisement database, such as database 112 shown in FIG. 1. If the advertiser does not approve the advertisement at block 312, the advertiser is given an opportunity to edit the advertisement (block 314) and preview the revised copy of the advertisement.

The following Table identifies multiple parameters that can be associated with advertisements. Certain advertisements may use a portion of the parameters shown in Table 1.

TABLE 1

| Parameter | Description | Example |
|---|---|---|
| Ad Type | Front-End Sponsor Ad, | Sponsor Ad for |
| | Back-End Sponsor Ad, | Pizza Delivery |
| | Competitive/Switch- | |
| | Away Ad, My Listing | |
| | Ad, Category Ad, Movie | |
| | Ad, Supermarket Ad, etc. | |
| Ad Category | Business category | Automobiles |
| Ad Sub-Category | Business sub-category | Porsche |
| | | Automobiles |
| Monthly Budget | Monthly limit across all | $5000/month |
| | advertisements | |
| Daily Budget | Daily limit across all | $200/day |
| | advertisements | |
| Ad Budget | Monthly limit per ad | $50 per ad/month |
| Day of Week | Days advertisement will | Friday through |
| | be played | Sunday |
| Time of Day | Times advertisement will | 9:00 am-3:00 pm |
| | be played | |
| Locality | Geographic area in | San Francisco |
| | which advertisement will | Metro Area |
| | be played | |
| Max Bid | Maximum amount the | $1.50/placement |
| | advertiser is willing to | |
| | pay for a single ad | |
| | placement or connection | |
| Throttle | Defines the maximum | Maxunum of 10 |
| | frequency of ad | calls per hour |
| | placement | |
| Routing | Defines the exit handling | Route to Order |
| | for an ad placement | Capture System |
| Audio Content | The audio file or | Acme.wav |
| | transcript containing the | |
| | voice content of the | |
| | advertisement | |
| Wireless Content | The image file or text | AcmeCoupon.jpg |
| | containing the wireless | (coupon image) |
| | content of the | |
| | advertisement | |

A particular advertisement may include some or all of the parameters identified in Table 1. For example, an advertisement that does not include an image or text will not have an associated Wireless Content parameter. The Locality parameter may be nationwide or define a state, city, metropolitan area, area code, or area code and prefix.

An advertisement for a pizza restaurant might have the hours for ad placement match the hours they are open, for example 11 am to 10 pm, with no throttle defined during most of the day. However, since they have lots of business between the hours of 5 to 7 pm, they would create a separate placement for that timeframe and could set the throttle to 12. This would mean that they would get no more than 12 calls per hour during those 2 hours, and these calls would be distributed over the 60 minutes, preferably occurring approximately once every five minutes. This would give the restaurant time to handle all their other customers.

There are many of types of ads that can be managed with this in-call advertisement system. In particular embodiments, five different types of advertisements could be used: front-end sponsor advertisements, back-end sponsor advertisements, competitive advertisements (also referred to as “switch-away advertisements”), my-listing advertisements, and category advertisements. Front-end sponsor ads are typically played to a caller as soon as the caller is connected to the service. A particular type of front-end sponsor ad, a targeted spot ad, selects among several ads to play based on information known about the caller. For example, if a particular caller has previously called directory assistance and requested pizza businesses, the advertisement management system will likely play a pizza-related sponsor ad for that caller. Additionally, the advertisement management system may charge more for a pizza-related advertisement played to this particular caller because the caller has previously requested pizza businesses before. For example, the advertiser is charged 35 cents for an advertisement played to a caller who previously requested a pizza business, and the advertiser is charged 25 cents for the same advertisement played to a caller who had not previously requested a pizza business.

A back-end sponsor ad is typically played when no “middle ad” has been played, such as a switch-away, my listing, or competitive ad. A “my listing” ad is an ad for the sponsor's business. A back-end sponsor ad is typically played if it matches and complements the front-end ad. In the example above, if a pizza-related ad was played to the caller and no middle ad was played, a back-end sponsor pizza ad from the same merchant could be played to the caller before the call transfer is made, to remind him one last time of their service, offer a coupon, or announce the daily special.

A competitive/switch-away advertisement is provided to a caller in response to the caller's request for a competitor's business. For example, if a caller requests the phone number for “Bob's Pizza”, a competitive ad would provide information (e.g., via an audio ad) to the caller regarding a different company (such as “Pizza Depot”), which is a competitor of “Bob's Pizza”. Competitive advertisements may be triggered in response to requests for one or more specific businesses or in response to a request for any business in a particular category. For example, an advertiser (Bob's Pizza) can create a competitive advertisement for callers requesting “Mike's Pizza”. In this example, the advertisement is only played when people request “Mike's Pizza”. Alternatively, the advertiser (still Bob's Pizza) can create a competitive advertisement for callers requesting any pizza business by name or any keyword. In this situation, the advertisement is played when a caller requests “Mike's Pizza”, “Roundhouse Pizza”, or any other pizza business meeting the locale and other parameters set by the advertiser.

A “my listing” ad is an advertisement that is triggered by a request from the caller for the advertiser's listing. In one example, a “my listing” advertisement is used to block a competitor from playing a competitive/switch-away advertisement. In another example, the advertiser has to out-bid the competitive/switch-away ads from the competitors.

A category advertisement is associated with a particular business category. When a caller asks to search by category, typically two or three ads would play matching the caller's category and the caller would be given an opportunity to be connected to one of the advertisers. Pricing for category advertisements can be set by auction (as described herein) or by paying a specific price to obtain a particular rank among the multiple ads. Alternatively, the cost of a category advertisement may have a cost associated with playing the ad to the caller, an additional cost for ranking the ad in one of the top positions for earlier playback to the caller, and an additional cost if that ad is selected by the caller.

Pricing on advertisements is typically set in an auction, based on maximum bid information provided by the advertiser when creating or placing the advertisement. Pricing may vary depending on the type of ad, time-of-day, day-of-week, and so forth. When an advertiser is creating or editing an ad, the advertisement management system reports the current high bids for the same category of advertisement in the same locale. Reporting current high bids lets the advertiser choosing a maximum bid for their advertisement. For example, if the top three bids are “30 cents”, “35 cents” and “50 cents”, and the advertiser bids less than 30 cents, their ad will not likely be one of the top three ads provided to callers. Based on the advertiser's bid, the advertisement management system determines the placement of that ad among other competing ads.

In a particular embodiment, if a particular ad is pushed out of the “top three” ads for a particular category and locale, the advertiser associated with the “pushed out” ad is notified via an outbound call, email, text message, or other notification system. The advertiser associated with the “pushed out” ad is given the current top three bids for the particular category and locale. The advertiser is then given an opportunity to increase the bid for their ad to put their ad back in the “top three” ads for the particular category and locale. For example, the advertiser can simply press a particular button on their phone or click a button in an email message to automatically increase their maximum bid to keep their advertisement in the top three positions (or press/click a different button to automatically increase their maximum bid to keep their advertisement in the top position. In other embodiments, an advertiser is notified if their ad is pushed out of the top position, the top two positions, or any other number of top positions.

When setting maximum bid values for advertisements, the advertiser can also specify a daily maximum value for each advertisement, for a group of advertisements, or for all of the advertisements associated with a particular advertiser. Similarly, the advertiser can specify a weekly or monthly maximum value for each advertisement, for a group of advertisements, or for all advertisements associated with a particular advertiser.

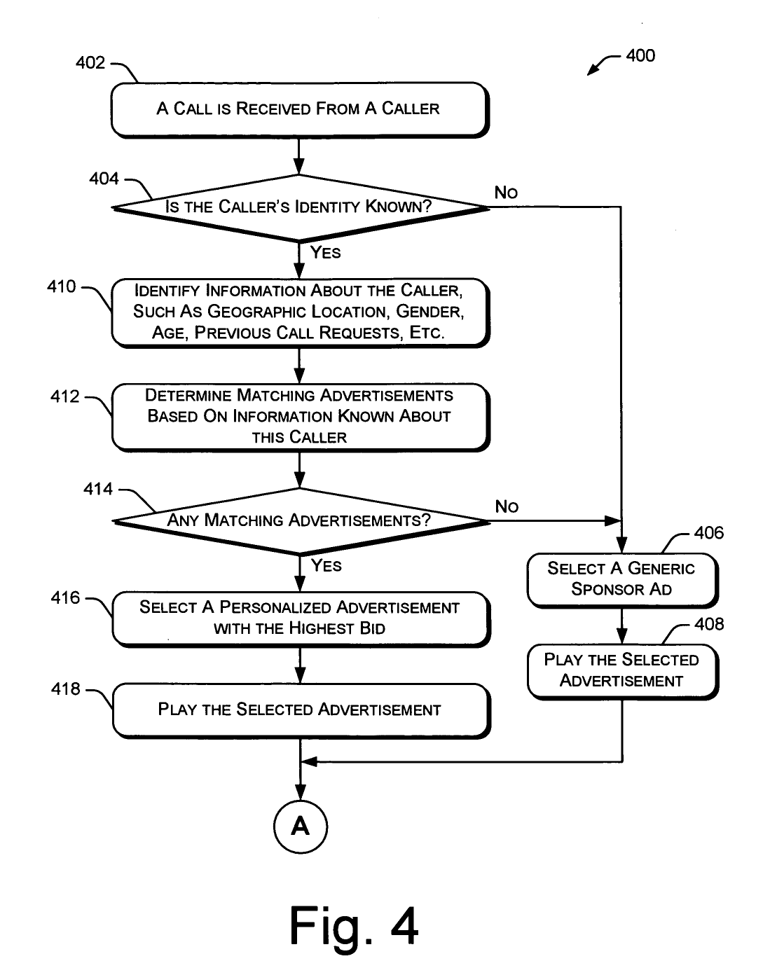

FIGS. 4-7 represent a flow diagram that illustrates an embodiment of a procedure 400 for playing one or more advertisements to a caller. Initially a call is received from a caller (block 402). Procedure 400 then determines whether the caller's identity is known, for example, by accessing a caller database and identifying the caller's identity based on the incoming call phone number (block 404). If the caller's identity is not known (e.g., no incoming call phone number or no record in the caller database), the procedure branches to block 406 where a generic sponsor advertisement is selected. Non-targeted sponsor ads are played based on bid value. If all bid values are the same, the ad that was played the longest time ago would be played next. Alternatively, if all bid values are the same, an advertisement may be selected at random. The selected advertisement is then played for the caller (block 408). This type of advertisement is an example of a front-end sponsor advertisement.

If the caller's identity is known at block 404, the procedure continues to block 410 where procedure 400 determines information about the caller, such as the geographic location of the caller, the caller's gender, the caller's age, one or more business categories associated with previous directory assistance requests, or other known data about the caller. The procedure then determines whether the advertisement management system contains any available advertisements that match the interests or preferences of the caller (block 412). If not, the procedure branches to block 406 to select a generic sponsor advertisement and then to block 408 to play the selected advertisement.

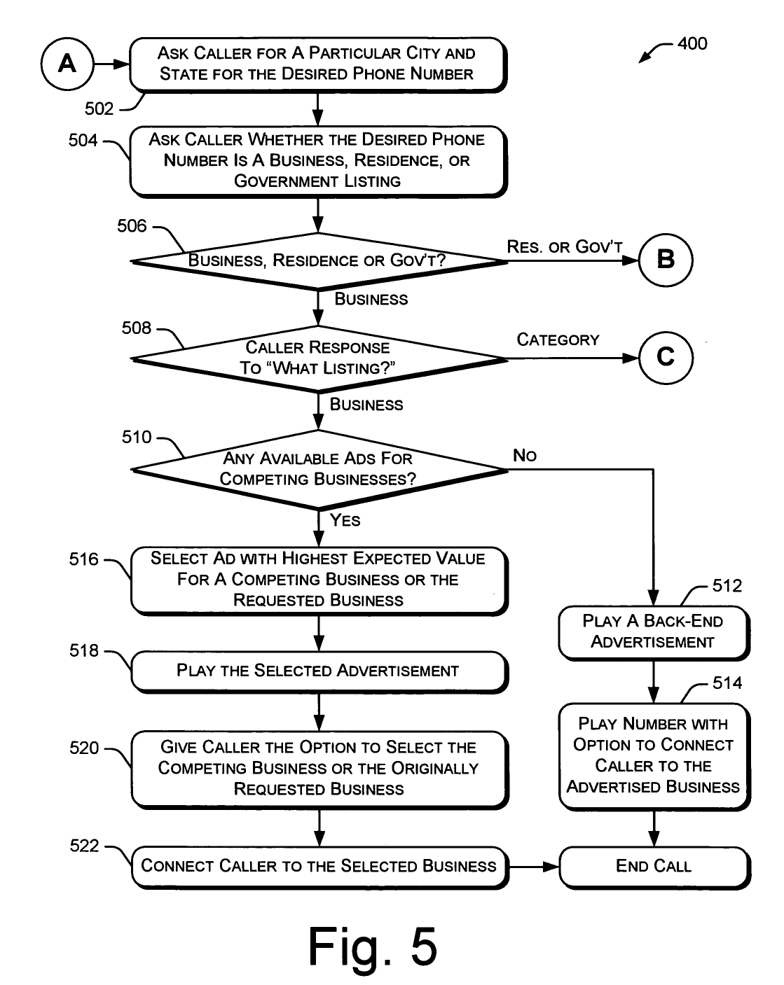

If procedure 400 determines that the advertisement management system contains one or more available advertisements that match the interests or preferences of the caller, the procedure selects a personalized advertisement with the highest bid (block 416). Next, the procedure plays the selected advertisement (block 418) and continues with the call at point “A” in FIG. 5.

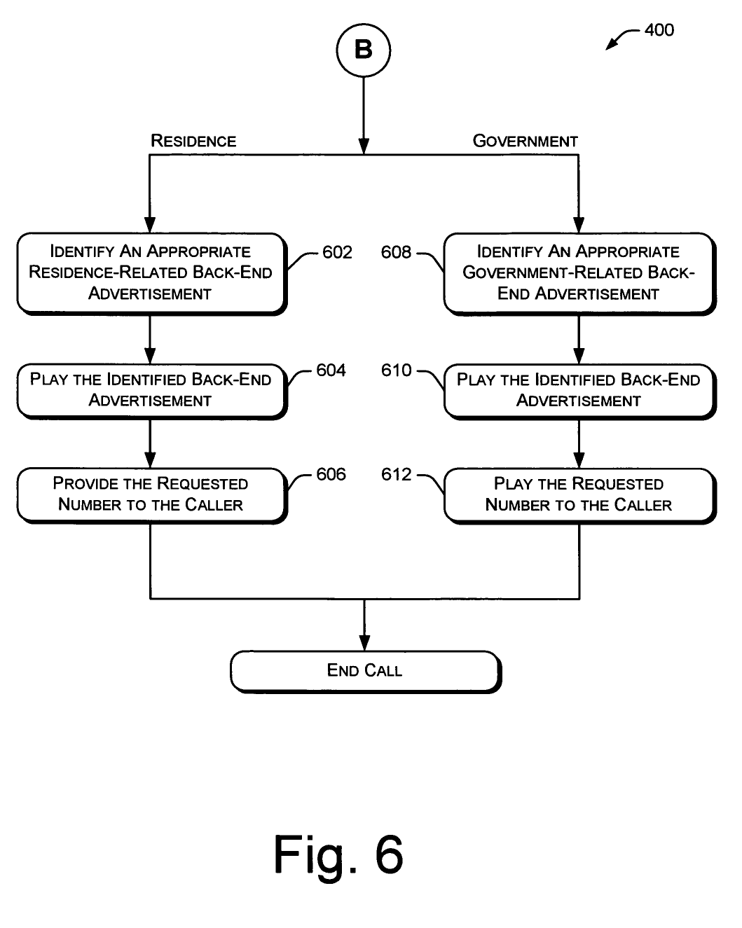

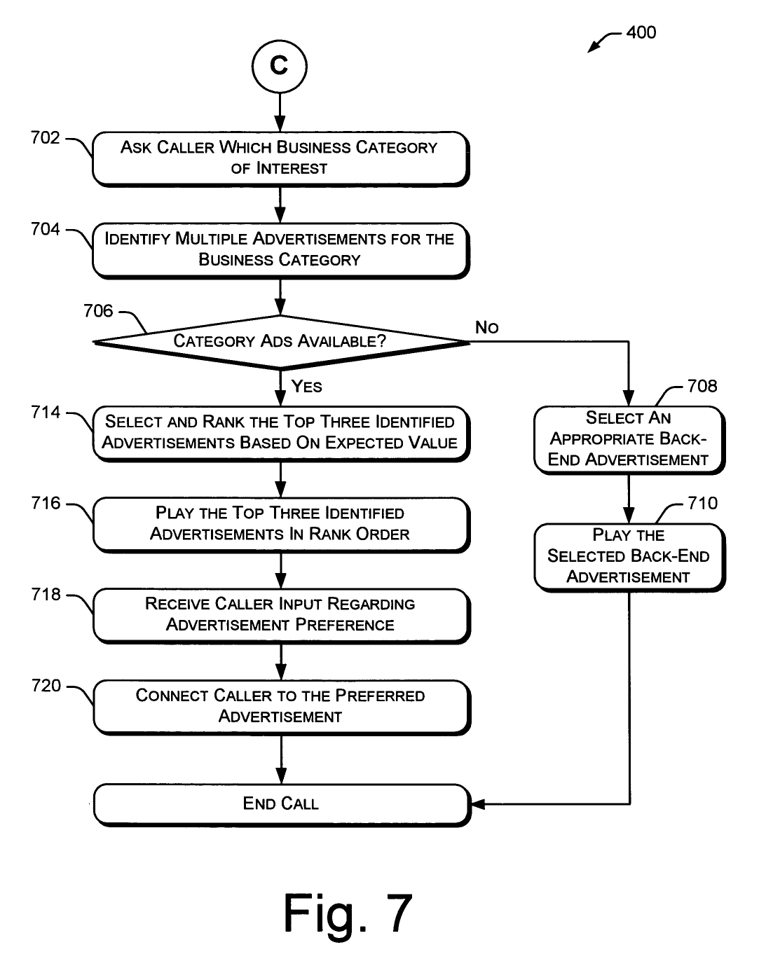

In FIG. 5, procedure 500 continues as the automated or live operator asks the caller for the city and state of their search (block 502). Next, the operator will ask if it is a search for a business, government, or residential listing (block 504). If the search is for a government or residence listing, the call branches to point “B” in FIG. 6. If the search is a request for a business, the procedure continues to block 508, where the operator asks the caller “what listing?” If the caller's response is for a particular category of business, the procedure branches to point “C” in FIG. 7. Otherwise, the caller's response is treated as a request for a business listing, and the procedure determines whether the advertisement management system contains a “my listing” ad for that particular business or any available advertisements for competing businesses (block 510). If not, the procedure branches to block 512 to select and play an appropriate back-end sponsor advertisement and then to block 514 to play the number with the option to connect the caller to the advertised business.

If procedure 400 determines that the advertisement management system contains one or more viable advertisements for the business, the procedure selects the advertisement with the highest expected value (block 516). An ad is deemed viable if it matches all the business rules of the advertiser, such as time-of-day, day-of-week, location, budget, throttle, etc. When selecting an advertisement with the highest expected value (i.e., an advertisement that is expected to generate the highest revenue for the entity providing the advertising service), the process may consider bids for various types of ads. For example, the procedure may consider bids for “my listing” type advertisements as compared to “switch away” type advertisements for competing businesses. If a particular “my listing” advertisement has a bid of $1.00 and a related “switch away” advertisement has a bid of $1.50, the procedure will select the “switch away” advertisement instead of the “my listing” advertisement.

Procedure 500 then plays the selected advertisement (block 518) and gives the caller the option to select the competing business or the originally requested business (block 520). The caller is then connected to the selected business (block 522). Finally, the procedure ends the current call.

All viable competitive ads and category ads are selected based on their bid values and expected value. In one example, a caller to a business listing can be redirected 40% of the time to a competitor if a coupon is offered by the advertiser, but only 20% of the time if no coupon is offered. In a particular situation, the caller is asking for “Bob's Pizza” and there are two viable ads for that time of day and day of week. One ad, with no coupon has a bid of $4.00, while another ad with a coupon has a bid of $3.00. The system would play the $3.00 ad since its expected value is $1.20 ($3.00×40%) while the other ad had an expected value of $0.80 ($4.00×20%).

In the example above, coupons can be sent to a caller's phone, personal digital assistant (PDA), fax machine, email address, or other device/account for display or other rendering on the phone or other device. Such coupons are particularly useful with competitive advertisements. In addition to coupons, the caller may be sent maps, directions, product photos, and the like. These items may be in a text format, a visual format (such as JPEG), an HTML format, or any other format understood by the receiving device.

In FIG. 6, procedure 400 continues from point “B” by following the left path if the caller requested a residence and following the right path if the caller requested a government listing. If the caller requested a residence listing, the procedure identifies an appropriate back-end advertisement for the caller (block 602). For example, the procedure may select a back-end advertisement that is associated with a previously played front-end advertisement. The procedure then plays the identified back-end advertisement (block 604). Finally, procedure 400 provides the number associated with the requested listing to the caller (block 606). The procedure then ends the call.

If the caller requested a government listing, the procedure identifies an appropriate back-end advertisement for the caller (block 608). The procedure then plays the identified back-end advertisement (block 610). Next, procedure 400 provides the number associated with the requested listing to the caller (block 612). The procedure then ends the call.

In FIG. 7, procedure 400 continues from point “C” by asking the caller what business category they are seeking (block 702). The procedure continues by identifying multiple advertisements for businesses in the requested business category (block 704).

If there are no viable ads that match the requested business category, the system will read out the names of numbers of the listings to the caller, then the ad system will select an appropriate back-end sponsor advertisement (block 708). The system then plays the selected back-end sponsor ad (block 710).

If there are viable ads that match the category request of the caller, one embodiment of the advertisement management system selects and ranks the top three identified advertisements, based on their expected value (block 714). In alternate embodiments, the advertisement management system selects and ranks any number of top identified advertisements (such as the top two advertisements or the top five advertisements).

Procedure 400 continues by playing the top three identified advertisements in rank order (block 716). Next, the procedure receives caller input regarding their advertisement preference (block 718) and connects the caller to the source of the preferred advertisement (block 720). The procedure then ends the call.

In alternate embodiments, a caller may provide one or more keywords instead of the name of a company. For example, a caller may request “pipe repair” rather than “plumber” or “Bob's Plumbing”. In this situation, the systems and methods described herein search for businesses that most closely match the keyword provided by the caller. The systems and methods may then identify one or more advertisements to play for the caller following the procedures discussed herein.

The advertising management system discussed herein collects information regarding advertisement statistics for reporting to advertisers. For example, the advertising management system stores information regarding the number of times an advertisement is played to a caller, the number of times an advertisement is selected by a caller, the cost of each advertisement playback, the ranking position of each advertisement playback, and so forth. This information is reported to advertisers to allow the advertisers to evaluate the results of their advertising campaigns.

As mentioned above, in certain embodiments an application program interface (API) is provided by advertising management system 106 (FIG. 1) that allows one or more invoking applications to interact with the advertising management system. Example API parameters include geographic locality, business category, number of advertisements desired, dialed number information service (DNIS) data, and automatic number information (ANI) data.

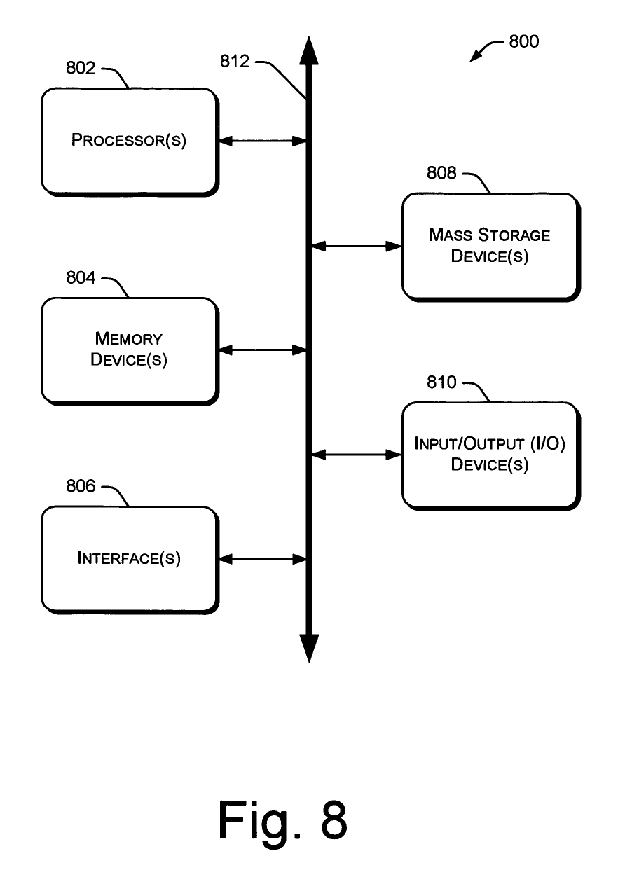

FIG. 8 is a block diagram illustrating an example computing device 800. Computing device 800 may be used to perform various procedures, such as those discussed herein. Computing device 800 can function as a server, a client, or any other computing entity. Computing device 800 can be any of a wide variety of computing devices, such as a desktop computer, a notebook computer, a server computer, a handheld computer, and the like.

Computing device 800 includes one or more processor(s) 802, one or more memory device(s) 804, one or more interface(s) 806, one or more mass storage device(s) 808, and one or more Input/Output (I/O) device(s) 810, all of which are coupled to a bus 812. Processor(s) 802 include one or more processors or controllers that execute instructions stored in memory device(s) 804 and/or mass storage device(s) 808. Processor(s) 802 may also include various types of computer-readable media, such as cache memory.

Memory device(s) 804 include various computer-readable media, such as volatile memory (e.g., random access memory (RAM)) and/or nonvolatile memory (e.g., read-only memory (ROM)). Memory device(s) 804 may also include rewritable ROM, such as Flash memory.

Mass storage device(s) 808 include various computer readable media, such as magnetic tapes, magnetic disks, optical disks, solid state memory (e.g., Flash memory), and so forth. Various drives may also be included in mass storage device(s) 808 to enable reading from and/or writing to the various computer readable media. Mass storage device(s) 808 include removable media and/or non-removable media.

I/O device(s) 810 include various devices that allow data and/or other information to be input to or retrieved from computing device 800. Example I/O device(s) 810 include cursor control devices, keyboards, keypads, microphones, monitors or other display devices, speakers, printers, network interface cards, modems, lenses, CCDs or other image capture devices, and the like.

Interface(s) 806 include various interfaces that allow computing device 800 to interact with other systems, devices, or computing environments. Example interface(s) 806 include any number of different network interfaces, such as interfaces to local area networks (LANs), wide area networks (WANs), wireless networks, and the Internet.

Bus 812 allows processor(s) 802, memory device(s) 804, interface(s) 806, mass storage device(s) 808, and I/O device(s) 810 to communicate with one another, as well as other devices or components coupled to bus 812. Bus 812 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 800, and are executed by processor(s) 802. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving a directory assistance request from a caller;
attempting to determine the identity of the caller;
if the caller's identity cannot be determined, playing a sponsor advertisement prior to providing the directory assistance service to the caller; and
if the caller's identity is determined:
identifying a plurality of advertisements of possible interest to the caller, wherein each of the plurality of advertisements has an associated bid price;
selecting an advertisement having a highest associated bid price; and
playing the selected advertisement to the caller.

2. A method as recited in claim 1 wherein the bid price associated with each advertisement is determined by a sponsor of the advertisement.

3. A method as recited in claim 2 wherein the bid price is set as a maximum price the sponsor will pay for each playback of the advertisement.

4. A method as recited in claim 2 wherein the bid price is set by the sponsor via a telephone-based interface.

5. A method as recited in claim 2 wherein the bid price is set by the sponsor via an Internet-based interface.

6. A method as recited in claim 1 further comprising providing the directory assistance service to the caller after playing the selected advertisement to the caller.

7. A method comprising:
receiving a request to create an audio advertisement from an advertisement sponsor;
receiving audio information from the advertisement sponsor;
filtering the received audio information;
receiving a parameter associated with the audio advertisement;
providing a preview of the audio advertisement and the parameter to the sponsor; and
storing the audio advertisement and the parameter associated with the audio advertisement.

8. A method as recited in claim 7 wherein the parameter associated with the audio advertisement is a maximum bid price for the audio advertisement.

9. A method as recited in claim 7 wherein the parameter associated with the audio advertisement is an indicator of the type of business associated with the audio advertisement.

10. A method as recited in claim 7 wherein the parameter associated with the audio advertisement is a geographic area associated with the audio advertisement.

11. A method as recited in claim 7 wherein the parameter associated with the audio advertisement is a maximum number of times to play the audio advertisement during a specified time period.

12. A method as recited in claim 7 wherein the audio information is received via a telephone-based interface.

13. A method as recited in claim 7 wherein the audio information is received via a data communication network.

14. A method comprising:
receiving an advertisement from an advertisement sponsor;
receiving a maximum bid price associated with the advertisement;
determining a category associated with the advertisement;
identifying other advertisements in the same category as the advertisement;
ranking all advertisements in the category based on maximum bid price; and
for each advertisement in the category that is not ranked in the top x positions, notifying a sponsor associated with the advertisement that the advertisement is not ranked in the top x positions.

15. A method as recited in claim 14 wherein notifying a sponsor associated with the advertisement further includes allowing the sponsor associated with the advertisement to increase the maximum bid associated with the advertisement.

16. A method as recited in claim 14 wherein notifying a sponsor associated with the advertisement further includes identifying the maximum bids associated with the top x positions.

17. A method as recited in claim 14 wherein the value of x varies between different advertisements.

18. A method as recited in claim 14 wherein identifying other advertisements in the same category include identifying advertisements that are eligible for playing during the same time period as the received advertisement.

19. A method as recited in claim 14 wherein identifying other advertisements in the same category include identifying advertisements that are eligible for playing in the same geographic area as the received advertisement.

20. A method as recited in claim 14 further comprising re-ranking all advertisements in the category based on maximum bid price if the sponsor associated with the advertisement increases the maximum bid associated with the advertisement.
